(19) United States
(12) Patent Application Publication
(10) Pub. No.: US 2005/0066767 A1
(43) Pub. Date: Mar. 31, 2005

(54) Snap together linear vibration damper and method for assembly related application

(76) Inventor: John W. Patterson, Hillsdale, MI (US)

Correspondence Address: MCDONALD HOPKINS CO., LPA, 2100 BANK ONE CENTER, 600 SUPERIOR AVENUE, E., CLEVELAND, OH, 44114-2653, US

(21) Appl. No.: 10/873,421

(22) Filed: Jun. 21, 2004

Related U.S. Application Data
(60) Provisional application No. 60/506,588, filed on Sep. 26, 2003.
(60) Provisional application No. 60/528,348, filed on Dec. 10, 2003.

(51) Int. Cl. F16F 15/10

(52) U.S. Cl. 74/574

(57) ABSTRACT

A damper assembly and method of assembling a damper assembly wherein the damper assembly comprises an inertia member having a chamber therein, wherein an elastomer and a portion of a support member are retained under compression within the chamber by a snap-fitting retainer member. Also disclosed is another embodiment of the damper assembly and method of assembling a damper assembly comprising a support hub having a chamber therein, an inertia member having a protuberance extending therefrom and capable of insertion within a groove of an elastomer, wherein the elastomer and the protuberance are retained under compression within the chamber by a snap-fitting retainer member.

### RELATED APPLICATION

This application claims the benefit of priority from U.S. provisional application Ser. No. 60/506,588 filed on Sep. 26, 2003 and U.S. provisional application Ser. No. 60/528,348 filed Dec. 10, 2003.

### FIELD OF INVENTION

The present invention relates generally to linear vibration dampers, and in particular, to snap together linear vibration dampers and methods for assembly of same.

### BACKGROUND

Damping devices, and in particular dynamic damping devices, are widely used to dampen vibrations of an object. Particularly, the automotive industry uses dynamic damping devices to dampen vibrations imparted on components by the engine, the tires, and road conditions.

It is known in the art to dampen mechanically produced dynamic vibrations by interposing an elastomer between components. Typically, an elastomer is bonded or interposed between an inertia mass and a support member connected directly to the object requiring dampening. Interposing the elastomer between the inertia mass and the support member places the inertia mass in elastomer suspension relative to the support member so as to absorb and dissipate vibrations of the object to be dampened. However, there are numerous disadvantages to such dampers and the construction.

It is common to bond the elastomer to the support member and inertia mass, which usually are made of metal, by adhesives, heat treatments, vulcanizing, or the like. However, as the dynamic character of the damper imposes considerable stress on the damper components, difficulty has been encountered in successfully using conventional bonding and vulcanizing techniques to maintain structural and functional integrity. Therefore, failure of conventionally constructed vibration dampers is common. Further, such conventional dampers may be complex in design and difficult and costly to manufacture in an economic manner. Also, given these construction and operational limitations, extended life cycles are difficult to achieve.

Therefore, there is a constant need in the art to improve the design and assembly of such dampers. Further, there is a need to provide a damper that is easier and cheaper to manufacture. Further, there is a need in the art to extend the life cycles of dampers in a more cost effective manner.

### SUMMARY OF THE INVENTION

It is an object of the present invention to provide a dynamic linear vibration damper of an economical construction that has an extended operational life and yet is economical to produce and assemble.

It is a further object of the present invention to provide a damper capable of easy assembly through a snap-fit construction. The assembly also promotes the disassembly of dampers and replacement of worn parts.

Another object of the present invention is to provide a damper and construction easily assembled from interchangeable components thereby reducing production time and cost.

Yet another object of the invention is to provide a dynamic linear vibration damper capable of damping a wide range of vibration frequencies, wherein the damper is of such configuration and operation as to be suitable for a wide variety of applications.

The objects of the present invention are satisfied by providing a damper and a method of assembling such a damper comprising an inertia member having a chamber therein, wherein access to said chamber is defined by a flange, an elastomer having a support-receiving groove therein and capable of placement within the chamber, a support member capable of being held within the support-receiving groove, and a retainer member capable of snap fitting over the flange portion to hold the support member under compression within the elastomer groove and within the chamber.

The present invention will be more fully described in the following written description with reference to the accompanying drawings.

### BRIEF DESCRIPTION OF THE SEVERAL VIEWS OF THE DRAWING

FIG. 1 is an exploded view showing the components of a first embodiment of a linear vibration damper assembly according to the present invention.

FIG. 2 is a cross-sectional view of the assembled damper of FIG. 1.

FIG. 3 is front elevational view of the damper assembly of FIG. 2.

FIG. 4 is an exploded view showing the components of a second embodiment of a linear vibration damper assembly according to the present invention.

FIG. 5 is a cross-sectional view of the assembled damper of FIG. 4.

FIG. 6 is a front elevational view of the damper assembly of FIG. 5.

FIG. 7 is a cross-sectional view of a third embodiment of a linear vibration damper assembly according to the present invention.

FIG. 8 is a front elevational view of the damper assembly of FIG. 7.

### DETAILED DESCRIPTION OF THE INVENTION

Reference is now made to the drawings to further describe the present invention.

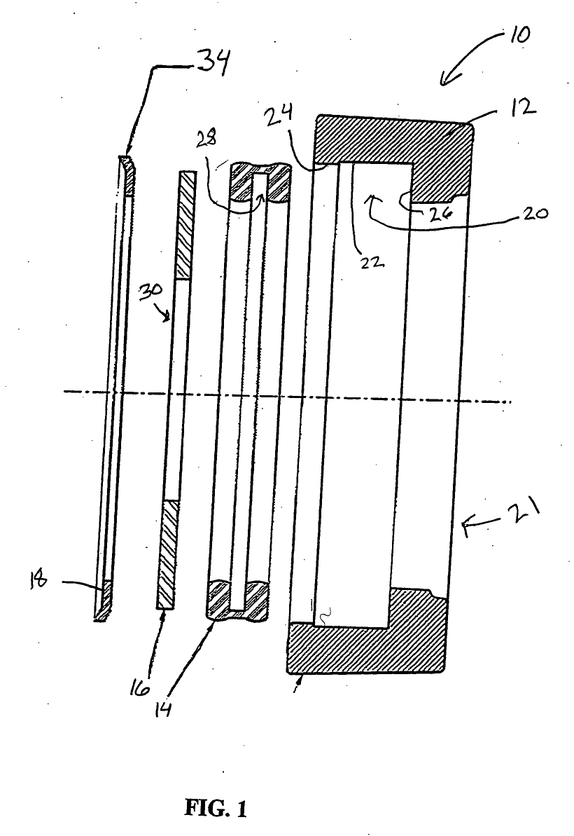

A first embodiment of a damper according to the present invention, and the preferred embodiment, is shown in FIGS. 1 through 3. As shown in FIG. 1, the damper assembly, generally designated 10, comprises an inertia member 12, an elastomer 14, a support member 16, and a retainer member 18.

The inertia member 12, or mass, is generally annular in shape and is manufactured from any relatively heavy suitable material, and may be cast, stamped, or otherwise fabricated. The inertia member 12 is most commonly manufactured from metal. The inertia member 12 includes a chamber 20 and an aperture 21. The chamber 20 is defined by the inner surface 22 of the inertia member 12 and intermediate a radially inwardly extending flange 24 and support surface 26. As will be more fully described below, access to the chamber 20 is defined by flange 24.

The elastomer 14 is generally annular in shape and capable of placement within chamber 20. The elastomer 14 is manufactured from any suitable elastomeric material of a natural or synthetic composition or a combination thereof. Although the elastomer 14 of the present invention is annular in shape, it is contemplated that any configuration could be utilized which is capable of placement within the chamber 20 including a split ring constructions or individual elastomer pieces placed periodically along the circumference of the chamber 20. The elastomer 14 further includes a groove 28 extending radially outwardly from the inner surface of the annular elastomer 14 capable of fitting over and retaining at least a portion of the support member 16.

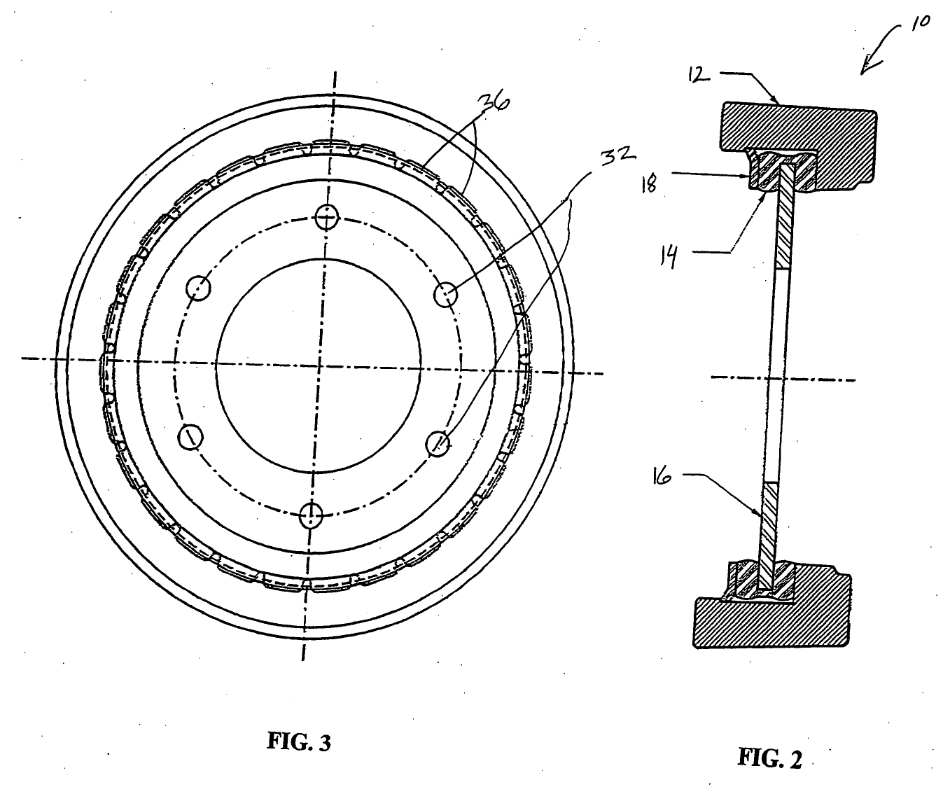

Support member 16 is generally disk-like in construction and includes an aperture 30 therethrough. The support member 16 may be manufactured from metal, plastic, resin, or any suitable material capable of supporting the damper assembly 10 on an object to be dampened. The present invention contemplates manufacturing the support member 16 from metal. As best shown in FIG. 3, support member 16 also includes periodically spaced apertures 32 that permit the support member 16 to be mounted to an object requiring dampening by bolts (not shown). However, other means for mounting the support member 16 to an object to be dampened are conceived including welding, gluing, having interlocking engagement members or any other suitable connection. As best shown in FIG. 2, the outer portion of the support member is capable of insertion within the groove 28 of the elastomer 14. While the disk-like support member construction is preferred, it is clear that other support member shapes could also be utilized including a star-shape, cross-shape, or other.

With reference again to FIG. 1, retainer member 18 is generally annular in shape and includes a flexible end portion 34 capable of flexing when the retainer member 18 is inserted through the chamber opening defined by flange 24. Although numerous constructions could be utilized, the first embodiment utilizes an annular retainer member 18 having tabs 36 (best shown in FIG. 3) extending at an angle from the retainer member 18 to provide flexibility to the end portion. The retainer member 18 may be manufactured from metal, plastic, resin, or any suitable material capable of snap fitting over the flange 24 and retaining the elastomer and support member within the chamber 22. The present invention preferably contemplates manufacturing the retainer member 18 from metal.

The damper assembly and method of assembling the damper 10 according to the first embodiment of the present invention is best shown with reference to FIG. 2. The outer portion of the support member 16 is inserted and held within the groove 28 of the elastomer 14. The elastomer 14 and support member 16 are then pressed over the circumferential flange 24 into chamber 20. The retainer member 18 is then pressed over the circumferential flange 24 wherein the tabs 36 flex until the tabs snap-fit into chamber 20. The components are constructed such that during the snap-fit engagement of the retainer member 18, the elastomer is compressed within the chamber so as to hold the support member 16 under compression within the chamber 20. Should disassembly be required to replace worn of damaged components of the damper 10, the retainer member 18 is removed and the elastomer and support member 16 can be removed from the chamber 20.

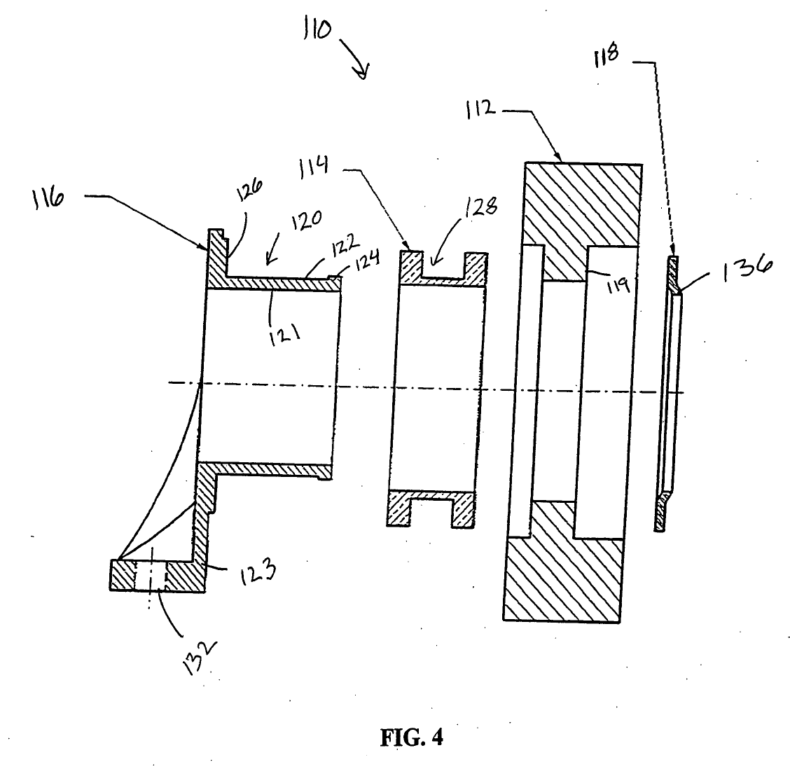

A second embodiment of a damper assembly is further described with reference to FIGS. 4 through 6. Generally, the second embodiment of the present invention utilizes a cylindrical hub as the support member instead of the disk-like support member of the first embodiment.

As best shown in FIG. 4, a damper assembly, generally designated 110, according to another embodiment of the present invention comprises an inertia member 112, an elastomer 114, a support member 116, and a retainer member 118.

Inertia member 112, or mass, is generally annular in shape and includes an inwardly extending protuberance 119. As will be more fully described below, the protuberance 119 is capable of fitting within a groove in the elastomer 114.

The elastomer 114 is a generally annular, cylindrical body including a groove 128 extending radially inwardly from an outer surface thereof. The elastomer groove is capable of fitting over and retaining at least a portion of the support member protuberance 119.

Support member 116 comprises a sleeve portion 121 having an outwardly extending base portion 123. The sleeve portion 121 is generally cylindrical in shape and generally resembles a hub. Base portion 123 includes at least one aperture 132 so as to permit the support member 116 to be mounted to an object requiring dampening by bolts (not shown). However, other means for mounting the support member 116 to an object to be dampened are conceived including welding, gluing, having interlocking engagement members or any other suitable connection. The sleeve portion 121 of the support member 116 includes a chamber 120 located along the outer surface of the sleeve portion 121. The chamber 120 is defined by the outer surface 122 of the sleeve portion 121 and intermediate a radially outwardly extending flange 124 and support surface 126. As will be more fully described below, access to the chamber is defined by flange 124.

Retainer member 118 is generally annular in shape and includes a flexible inner portion 136 capable of flexing when the retainer member 118 is inserted over the flange 124. Although numerous constructions could be utilized, the second embodiment utilizes an annular member having inwardly extending tabs 136 extending at an angle from the retainer member 118 to provide the flexible inner portion. The retainer member 118 may be manufactured from metal, plastic, resin, or any suitable material capable of snap fitting over the flange 124 and retaining the elastomer 114 and protuberance 119 within the chamber 120. The present invention contemplates manufacturing the retainer member 118 from metal.

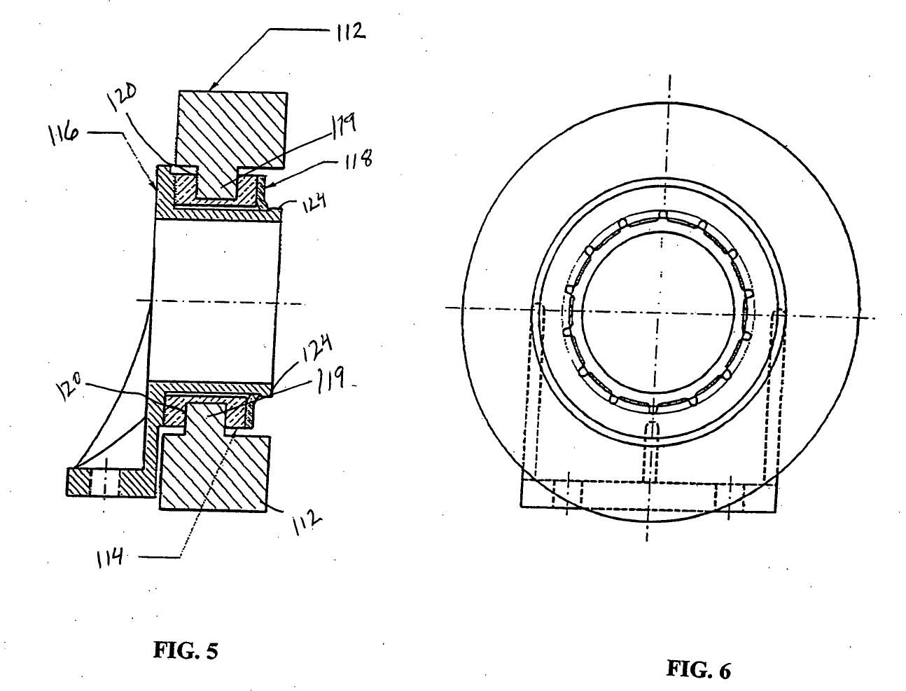

The damper assembly and method of assembling the damper 110 according to the second embodiment of the present invention is best shown with reference to FIG. 5. The protuberance 119 of the inertia member 112 is inserted and held within the groove 128 of the elastomer 114. The elastomer 114 and inertia member 112 are then pressed over the circumferential flange 124 into the chamber 120. The retainer member 118 is then pressed over the circumferential flange 124 wherein the inwardly extending tabs 136 flex until they snap-fit into chamber 120. The components are constructed such that during the snap-fit engagement of the retainer member 118, the elastomer 114 is compressed within the chamber 120 so as to hold the protuberance 119 under compression within the chamber 120. Should disassembly be required to replace worn of damaged components of the damper 110, the retainer member 118 is removed and the elastomer 114 and inertia mass 112 can be removed from the chamber 120.

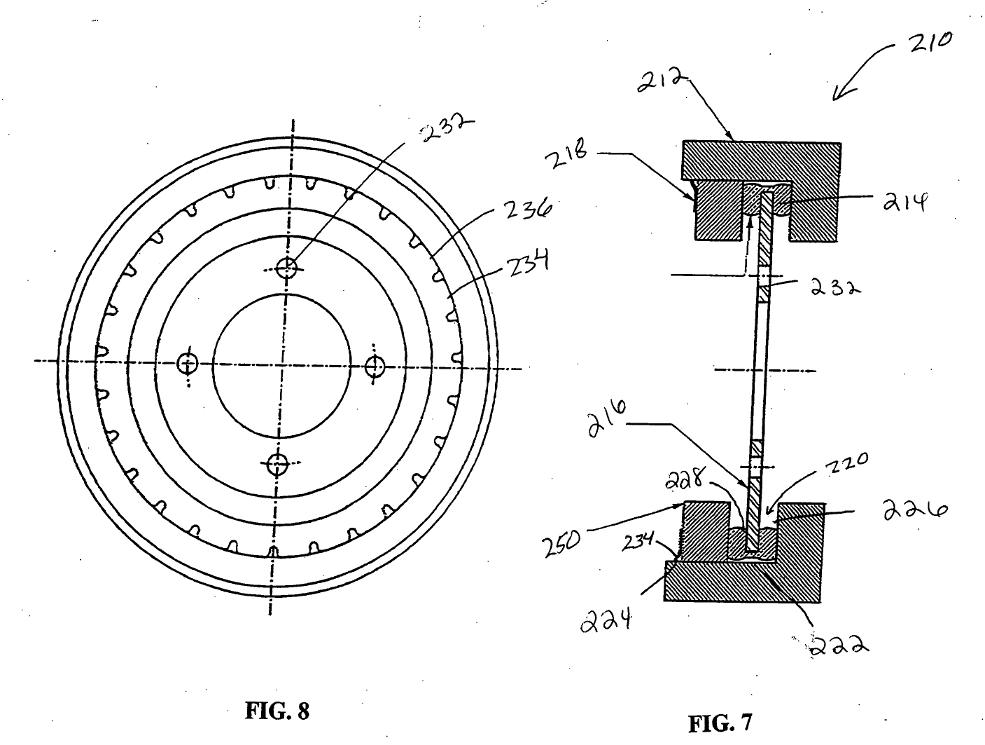

A third embodiment of a damper assembly is further described with reference to FIGS. 7 and 8. Generally, the third embodiment of the present invention utilizes a construction similar to the first embodiment. However, the retainer member comprises a thinner member and support of the assembly is assisted by insertion of an annular member within the chamber. Due to the similarity of construction between the first embodiment and the third embodiment, it should be clear that the description of the first embodiment is substantially applicable to the understanding of the third embodiment.

The inertia member 212, or mass, is generally annular in shape and includes a chamber 220. The chamber 220 is defined by the inner surface 222 of the inertia member 212 and intermediate a radially inwardly extending flange 224 and support surface 226. As will be more fully described below, access to the chamber 220 is defined by flange 224. However, it is also contemplated that the flange 224 could be replaced by a groove capable of snap-fitting the retainer member 218 in place.

The elastomer 214 is generally annular in shape and capable of placement within chamber 220. The elastomer 214 further includes a groove 228 extending radially outwardly from the inner surface of the annular elastomer capable of fitting over and retaining at least a portion of the support member 216.

Support member 216 is generally disk-like in construction and includes an aperture therethrough. Further, as shown in FIG. 8, support member 216 also includes periodically spaced apertures 232 that permit the support member 216 to be mounted to an object requiring dampening by bolts (not shown). As best shown in FIG. 7, the outer portion of the support member 216 is capable of insertion within the groove 228 of the elastomer 214.

Compression member 250 generally comprises an annular member that can be manufactured from the same material as the inertia member 212 so as to interact with the inertia member 212 to retainer the elastomer 214 and support member 216. The purpose of the compression member 250 is to increase the compressive mass so that a small or thinner retainer member 118 can be used during assembly of the damper.

Retainer member 218 is generally annular in shape and includes a flexible end portion 234 capable of flexing when the retainer member 218 is inserted through the chamber opening. Although numerous constructions could be utilized, the third embodiment utilizes an annular member having radially outwardly extending tabs 236 extending at an angle from the retainer member 218 to provide the flexible end portion.

The damper assembly and method of assembling the damper 210 according to the third embodiment of the present invention is best shown with reference to FIG. 7. The outer portion of the support member 216 is inserted and held within the groove 228 of the elastomer. The elastomer 214 and support member 216 are then inserted within the chamber 220 either over the circumferential flange 224 or over an inwardly extending annular groove 228 as explained above. The compression member 250 is then inserted within the chamber 220 so as to compress the elastomer and support member therein.

The retainer member 218 is either pressed over the circumferential flange 224 wherein the tabs 236 flex until the tabs snap-fit into chamber 220 or the retainer member is inserted within the chamber 220 until the flexed tabs enter the inwardly extending circumferential groove in the inertia member 212. Either way, the components are constructed such that during the snap-fit engagement of the retainer member 218, the compression member 250 compresses the elastomer 214 and the support member 216 within the chamber 220 so as to hold the support member 216 under compression within the chamber 220. Should disassembly be required to replace worn of damaged components of the damper 210, the retainer member 218 is removed and the compression member, the elastomer, and the support member can be removed from the chamber 220.

The invention has been described with reference to the preferred embodiment and other embodiments. Obviously, modifications and alternations will occur to others upon a reading and understanding of this specification. The claims as follows are intended to include all modifications and alterations insofar as they come within the scope of the claim or the equivalent thereof.

1. A damper assembly comprising:
an inertia member having a chamber therein, wherein access to said chamber is defined by a flange;
an elastomer capable of placement within said chamber, said elastomer having a support-receiving groove therein;
a support member having a portion capable of being held within said support-receiving groove of said elastomer;
a retainer member capable of snap fitting over said flange and into said chamber to hold said support member and said elastomer under compression within said chamber; and
means for connecting said damper assembly to an object to be dampened.

2. The damper assembly of claim 1 wherein said inertia member is annular and includes an inner surface.

3. The damper assembly of claim 2 wherein said chamber extends radially outwardly along said inner surface of said annular inertia member.

4. The damper assembly of claim 3 wherein said support member is circular.

5. The damper assembly of claim 4 wherein said retainer member is annular.

6. The damper assembly of claim 5 wherein said annular retainer member includes a flexible outer periphery.

7. The damper assembly of claim 1 wherein said means for connecting said damper assembly to a member to be dampened comprises at least one aperture located within said support member for receiving a bolt for fixing said support member to said member to be damped.

8. A damper assembly comprising:
an inertia member having an inner surface, a flange extending radially inwardly from said inner surface, a support surface extending radially inwardly from said inner surface, and a chamber defined by said inner surface, said flange, and said support surface;
an elastomer capable of placement within said chamber, said elastomer having a support-receiving groove therein;
a support member having a portion capable of being held within said support-receiving groove and a portion capable of connection to a member to be dampened; and
a retainer member capable of snap fitting over said flange portion to hold said support member and said elastomer under compression within said chamber.

9. The damper assembly of claim 8 wherein said inertia member is annular.

10. The damper assembly of claim 9 wherein said support member is circular.

11. The damper assembly of claim 10 wherein said annular retainer member includes a flexible outer periphery.

12. A damper assembly comprising:
an annular inertia member having an annular inner surface, an annular flange extending radially inwardly from said inner surface, an annular support surface extending radially inwardly from said inner surface, and an annular chamber defined by said inner surface, said flange, and said support surface;
at least one elastomer capable of placement within said chamber, said elastomer having a support-receiving groove therein;
a circular support member having a portion capable of being held within said support-receiving groove;
a retainer member capable of snap fitting over said flange portion to hold said support member and said elastomer under compression within said chamber.

13. The damper assembly of claim 12 wherein said elastomer is annular.

14. The damper assembly of claim 13 wherein said support-receiving groove is annular.

15. The damper assembly of claim 14 wherein at least a portion of the periphery of said annular retainer member is flexible.

16. A method for assembling a linear vibration damper, said method comprising the steps of:
providing an inertia member having a chamber therein, wherein access to said chamber is defined by a flange;
providing an annular elastomer having a support-receiving groove therein;
inserting at least a portion of the periphery of a support member into said support-receiving groove;
inserting said elastomer and said support member within said chamber;
inserting a retainer member over said flange so as to retaining said support member and said elastomer under compression within said chamber.
